(19) United States
(12) Patent Application Publication
(10) Pub. No.: US 2008/0202444 A1
(43) Pub. Date: Aug. 28, 2008

(54) METHOD AND SYSTEM FOR WEIGHING CONFINED LIVESTOCK, SUCH AS PENNED PIGS

(76) Inventors: Jerome Albin Stenzel, Cokato, MN (US); Ian Taylor, Cokato, MN (US)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 12/015,995

(22) Filed: Jan. 17, 2008

Related U.S. Application Data
(60) Provisional application No. 60/885,341, filed on Jan. 17, 2007.

(51) Int. Cl. A01K 1/02; G01G 19/52

(52) U.S. Cl. 119/480; 177/142

(57) ABSTRACT

Methods and systems for obtaining weight information of livestock in a confined area, such as penned pigs. The method includes locating a scale in the penned area, with the scale being appropriately configured to weigh a full grown pig and characterized as having an open construction. With this in mind, the method further includes pigs freely choosing to interact with scale as part of the pig's natural life pattern, with pig weights being obtained as part of this interaction.

### CROSS-REFERENCE TO RELATED APPLICATIONS

This application claims priority under 35 U.S.C. §119(e)(1) to U.S. Provisional Patent Application Ser. No. 60/885,341, filed Jan. 17, 2007, entitled “Method and System for Weighing Confined Livestock Such as Penned Hogs”, and bearing Attorney Docket No. B531.104.101; and the entire teachings of which are incorporated herein by reference.

### BACKGROUND

The present disclosure relates to the monitoring of livestock. More particularly, it relates to methods and systems for weighing livestock being reared in a confined area, such as pigs living in a pen.

Livestock production/management techniques, and equipment necessary to efficiently implement these methods, have greatly evolved over time. Conventional, large scale production of livestock generally entails the livestock being concentrated, housed and cared for within confined structures (e.g., pens, barns, etc.) that allow the grower to monitor and control the immediate environmental conditions to which the livestock is subjected. In addition, large scale production growers (as well as smaller-scale growers) find it highly beneficial to monitor various parameters relating to growth of the livestock (either individual animals or as a collective herd), such as weight, food consumption, water consumption, etc. This information, in turn, can be used by the grower to identify potential problems with the livestock herd, sort animals, etc. For example, within a “phase-specific” building or pen, livestock of similar age and weight (i.e., “phase” of production) are typically divided (e.g., penned) into sub-groups to both facilitate management and accommodate animal behavioral aspects that influence their growth and performance.

Commercial pig production management frequently employs one or more of the above techniques. In this regard, weight is viewed as being an important parameter for meaningful management both at the end of the production process (i.e., when sold on the market) as well as during the growth process. For example, a common pig production approach is to sort the animals of a herd according to different weight classifications as an indicator of suitability for being sold on the market. More recently, pig production management techniques have been advanced whereby the animals are, during the growth process, periodically weighed and then sorted (based on weight) between two or more pens. With this approach, then, pigs within one pen can be raised differently than pigs in a second pen (e.g., a grouping of pigs collectively deemed as being underweight can be fed at a different rate and/or different diet as compared to pigs viewed as being at an expected weight). Examples of this approach are provided in U.S. Pat. No. 6,837,189; WO03/103380; and US Pub. No. 2006/0260561.

In light of the above, a variety of different scales have been developed for purposes of weighing livestock, and in particular pigs. For example, sorter scales have been available for many years and are used to not only weigh individual animals, but also to guide the animal in a desired path (e.g., to a desired pen) based upon the observed weight. Generally, the sorter scale includes a closed-wall alley structure (i.e., solid, closed side panels) enclosing a weighing pan (i.e., a floor connected to a load cell) and various control mechanisms. A front door along with two or more rear doors or gates (each leading to different alley) are provided, all of which are electronically controlled. During use, the front door is automatically opened (e.g., pneumatically actuated) and the pig is allowed to enter. Once inside, the front door is automatically closed to capture the pig relative to the weighing pan. The pig's weight is determined, followed by automated opening of an appropriate rear door (based, in some instances on an analysis of the determined weight). The pig is then allowed to escape from the sorter scale via the opened rear door, thus being guided or forced to a desired area (e.g., pen).

While well-accepted, conventional pig sorter scales are intimidating, especially to the pigs themselves. Pigs are social creatures and are naturally curious of their surroundings. However, they are apprehensive of circumstances that isolate them from their social group. Further, pigs are easily spooked by sudden stimuli and thus are adverse to the fairly loud and sudden noises generated by operation of the sorter scale (e.g., automated opening and closing of doors). As such, pigs are frequently apprehensive about “entering” a sorter scale of their own volition. Rather, pigs often must be coaxed or even forced to use a conventional sorter scale. In certain instances, the need to force the pig into a sorting scale structure is not overtly problematic and/or is even expected, and handlers are readily available to assist in directing the pig into the sorter scale (e.g., when a herd of pigs is being brought to market for sale). In other instances, however, the unwillingness of pigs to interact with the sorter scale can lead to other complications.

For example, and as alluded to above, growers seek to obtain weight information for a herd of livestock (e.g., pigs) throughout the growing process/phases. Under these circumstances, it is impractical and cost prohibitive to routinely, if not daily, weigh all animals residing in a confined area (e.g., pen, barn, etc.). Instead, it has been proposed that a sorter scale be placed somewhere in the confined area, and the pigs allowed to randomly and passively interact with the sorter scale, be weighed, and a collective or representative weight of the herd be monitored over time. Conventional wisdom dictates that because sorter scales are “standard” tools for obtaining pig weight, they are appropriate for in-pen applications. However, given the strong aversion of pigs to the highly confined environment of sorter scales and the noises created during operation thereof, simply placing a sorter scale in the pen will not garner meaningful information. A majority of pigs may simply choose to avoid passage through the sorter scale. While handlers can periodically force the pigs into the sorter scale, this approach is not cost effective. Attempts have been made to entice the pigs to enter the sorter scale, for example by arranging the sorter scale such that the pigs must pass through in order to reach a feeding area (“food court”) and/or a watering area; providing a feeding station within the sorter scale; and providing a watering station within the sorter scale. While, in theory, these enticements should work, in practice they do not produce acceptable results. Rather, the pigs will avoid the sorter scale (and thus any feed or water offered or controlled by the sorter scale) for as long as possible, leading to insufficient weight gains and other health problems.

Other scales designed for weighing pigs have been proposed that while not incorporating the automated doors/gates associated with sorter scales, continue to include a confining, alley-type approach structure through which the pigs must traverse in order to be weighed. Unfortunately, pigs are equally intimidated by the alley due to its inherent (as naturally “perceived” by the pig) likelihood of forced conflict and physically blocked passage, and thus avoid the scale as much as possible. Further, alley-type scales place the load cell on the bottom of the platform on which the pig must stand while being weighed. While this approach may reduce the number and extent of side paneling, it gives rise to other problems; namely, the electronics/load cell is effectively positioned at ground level and thus is regularly subjected to manure and other contaminants in the pen. These environmental conditions, in turn, readily lead to operational failures.

In light of the above, a need exists for methods and systems for weighing livestock in a confined area (such as penned pigs) that requires minimal human interface but consistently generates meaningful herd weight information.

### BRIEF DESCRIPTION OF THE DRAWINGS

FIG. 1 is a block diagram of a system for obtaining weight information of confined livestock, such as pigs living in a penned area, and conducive to the methods of the present disclosure;

FIG. 2 is an exploded view of a scale useful with the system and methods of FIG. 1;

FIG. 3A is a perspective view of the scale of FIG. 2 upon final assembly;

FIG. 3B is a side view of the scale of FIG. 3A; and

FIG. 4 is a perspective view of another scale useful with the systems and methods of FIG. 1.

### DETAILED DESCRIPTION

Aspects in accordance with principles of the present disclosure relate to a method of weighing confined livestock, and in particular pigs being raised within a pen. As described in greater detail below, the present disclosure provides pig (and other livestock) weighing systems and methods in which a scale is placed in the animals' living environment and is configured such that the animals experience little or no aversion to interacting with (and thus being weighed by) the scale. To this end, the methods and systems are characterized by the pig interfacing with the scale as part of the pig's natural life pattern; the pigs do not have to be coaxed or forced to “use” the scale (e.g., additional enticements such as food and water are not required, nor is a human handler needed to force the pig on to the scale). Stated otherwise, the hogs (or other livestock) interact with the scale based on free choice. Under these circumstances, meaningful weight information relative to a herd of pigs (or other livestock) can be passively gathered without fear of harming the health and/or growth performance of the pigs. As used throughout this specification, the term “pig” is inclusive of swine or other related animals typically raised as livestock for market regardless of sex, age, or weight, and thus includes hogs, smaller or younger pigs, sows, boars, etc.

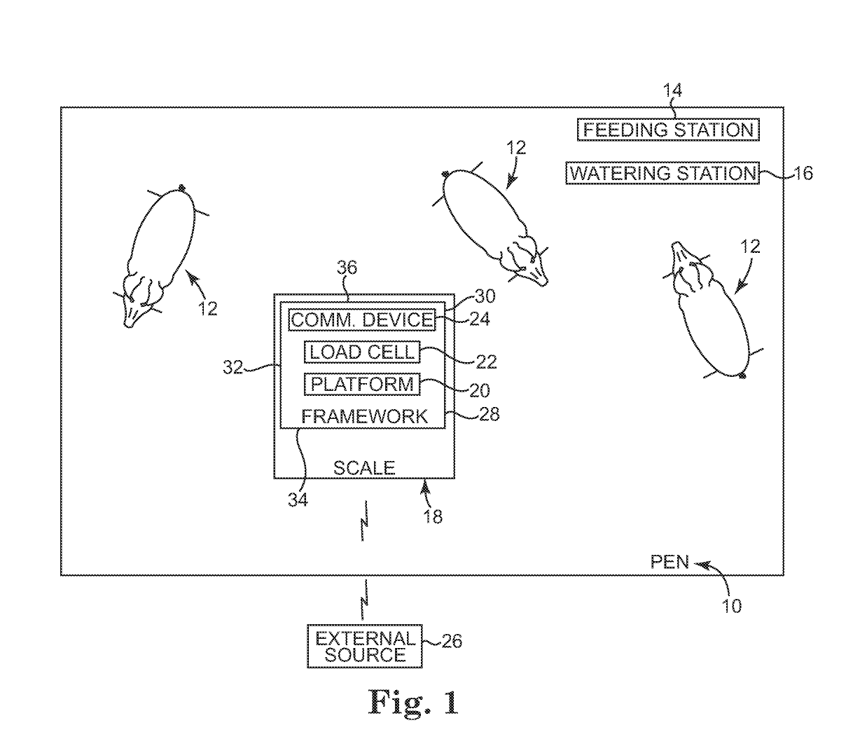

With the above in mind, FIG. 1 schematically illustrates a pen 10 with which the methods and systems of the present disclosure is useful. In general terms, the pen 10 can have any conventional construction, such as a barn, fenced area, etc. Regardless, pigs 12 (or other livestock animals) are raised in the pen 10, such that the pen 10 can include conventional features such as feeding station(s) 14, watering station(s) 16, etc. The pen 10 further includes a scale 18 in accordance with the present disclosure. The scale 18 can be placed at any location within the pen 10, and is in no way restricted to any particular arrangement relative to the feeding and/or watering station(s) 14, 16. Details on the scale 18 are provided below in connection with but one acceptable embodiment. Generally speaking, however, the scale 18 includes a platform 20, a load cell 22, and a communication device 24. The platform 20 is linked to the load cell 22 such that when one of the pigs 12 is on (or “interacts with”) the platform 20, the load cell 22 (or other weight-measuring mechanism/device) obtains a weight of the pig 12. In this regard, the platform 20 and load cell 22 are configured, in terms of size and construction, for weighing large animals, such as hogs that can otherwise reach weights in excess of 500 pounds. Regardless, the so-obtained weight is then communicated, via the communication device 24, to an external source 26 otherwise electronically connected (e.g., wired or wireless connection) to the communication device 24. In this regard, the scale 18 can include other electronic-related components (not shown), such as a programmable controller (as known in the art) that regulates operation of the scale 18 (including, for example, zeroing, calculations, etc.).

In addition to the above components, the scale 18 includes framework 28 that interconnects and supports the platform 20 relative to the load cell 22. In this regard, the framework 28 does not include, in some embodiments, any closed walls/panels, ceiling, doors, gates, etc. Instead, the framework 28 has an open construction, and can be generally characterized as defining first and second sides 30, 32, and first and second ends 34, 36. The sides 30, 32 may include one or more bars (not shown) that are vertically and/or horizontally spaced from one another such that an interior of the framework 28 is entirely visible through either of the sides 30 or 32. The ends 34, 36 are even less restrictive, defining a relatively large open area, bounded only by the platform 20 and a top bar (not shown) that is vertically spaced from the platform 20 by an appreciable distance (e.g., on the order of at least 30 inches alternatively on the order of at least 40 inches). With this construction, then, the framework 28, and thus the scale 18, is highly open in nature, in direct contrast to conventional pig sorter scales.

It has surprisingly been found that pigs exhibit little, if any, intimidation or apprehension when presented with the highly open scale 18 as described above. Pigs have been found to freely choose to interact with the scale 18 (i.e., walk on to the platform 20) without any separate enticements such as food or water. In fact, it has surprisingly been found that due to the non-intimidating nature of the scale 18, not only is a pig not afraid of the scale 18, but this lack of fear allows the pig's curiosity traits to take effect, such that pigs actually prefer to periodically walk over the scale 18/platform 20; it is theorized that this preference or decision occurs naturally to pigs as “something to do” in breaking up the monotony of the day. Regardless, in some embodiments, the load cell 22 and related components of the scale 18 (such as connective link(s) provided by the framework 28 between the platform 20 and the load cell 22) are configured to generate minimal, if any, noise during a weighing operation, and the platform 20 moves only a minimal amount (on the order of less than 0.25 inch in the presence of a 200-pound pig) thereby minimizing or eliminating other possible attributes that tend to intimidate a pig.

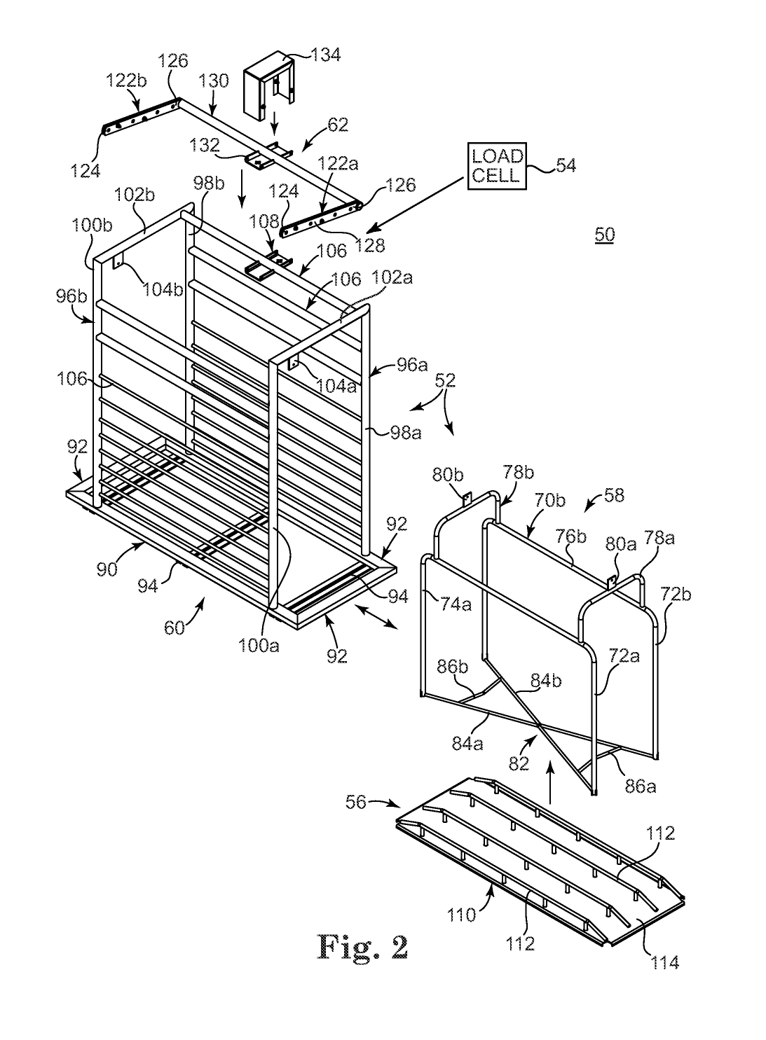

With the above in mind, FIG. 2 illustrates, in exploded form, components of a scale 50 useful with methods and systems of the present disclosure. It will be understood that the scale 50 is but one acceptable embodiment, and a variety of other configuration can be used as the scale 18 of FIG. 1. In general terms, the scale 50 includes framework 52 (referenced generally), a load cell 54 (shown in block form), and a platform 56 (illustrated schematically). The framework 52 includes a hanger frame 58, a support frame 60, and a pivot frame 62. As described in greater detail below, the framework 52 links the load cell 54 and the platform 56 to facilitate weighing of an object (e.g., a hog) placed on the platform 56. To this end, the framework 52 establishes a “hanging scale” relationship, such that the load cell 54 can be maintained at or near a top of the scale 50 (and thus well above ground level). Regardless, weight information is signaled to an external source via a communication device (not shown) associated with the load cell 54, such as a wireless transceiver as is known in the art.

The hanger frame 58 includes first and second side supports 70a, 70b. The side supports 70a, 70b are identical in construction, and each include opposed vertical end members 72a, 74a or 72b, 74b, and a horizontal member 76a or 76b. First and second top struts 78a, 78b extend between and interconnect the horizontal members 76a, 76b adjacent the end members 72a/72b, 74a/74b. Further, a hanger plate 80a, 80b is attached to and extends upwardly from a corresponding one of the struts 78a, 78b in defining a top of the hanger frame 58. Conversely, a floor support 82 is provided, and includes first and second beams 84a, 84b extending between and interconnecting the side supports 70a, 70b as shown. Connection between the beams 84a, 84b is further enhanced by first and second cross bars 86a, 86b.

In some embodiments, the various components of the hanger frame 58 are metal (e.g., steel) tubes, rods, or beams, rigidly affixed to one another (e.g., welded). As described below, the hanger frame 58 maintains the platform 56 relative to other components of the scale 50, and thus serves to define end openings of the scale 50 through which a pig will traverse. With this in mind, the hanger frame 58 can assume a variety of dimensions, but preferably has a horizontal spacing between the side supports 70a, 70b on the order of at least 14 inches, alternatively at least 16 inches or at least 17 inches, to provide more than sufficient space for ingress and egress of a pig through the scale 50.

The support frame 60 includes a base 90 defined by outer floor beams 92 (referenced generally) and interconnected by one or more cross beams 94. First and second uprights 96a, 96b extend upwardly from the base 90. The uprights 96a, 96b are laterally spaced from one another, and each include first and second vertical members 98a, 100a or 98b, 100b and a top member 102a, 102b. As shown, the top members 102a, 102b are located opposite the base 90, and an offset hanger plate 104a, 104b extends therefrom, respectively. A plurality of spaced, horizontal supports 106 extend between the first vertical members 98a, 98b, as well as between the second vertical members 100a, 100b. In this regard, a bracket 108 is attached to an uppermost one of the supports 106 and serves to at least partially support the load cell 54 or other electrical components as described below.

As with the hanger frame 58, the various components of the support frame 60 are formed of a high strength material, such as metal (e.g., steel) tubes, rods, or beams, and are rigidly affixed to one another (e.g., welded).

The platform 56 can assume a variety of forms amenable for repeated contact with a pig, and includes a floor 110. For example, the floor 110 can be a steel or other metal body. In some embodiments, the platform 56 can further include one or more features intended to dissuade a pig from remaining on the floor 110 for extended periods (for example, laying down on the platform 56). For example, the one or more spaced rails 112 are provided, located upwardly relative to a top surface 114 of the floor 110. While the rails 112 do not overtly impede a pig from walking across the floor surface 114, a pig will find the rails 112 uncomfortable when attempting to lie on the top surface 114/rails 112.

The pivot frame 62 provides a linkage between the hanger frame 58 and the support frame 60, as well as between the hanger frame 58 (and thus the platform 56) and the load cell 54. The pivot frame 62 includes first and second pivot arms 122a, 122b each having a first end 124, a second end 126 and an intermediate segment 128 therebetween. A load beam 130 interconnects the second ends 126 of the pivot arms 122a, 122b, and carries a bracket 132 configured to interface with the load cell 54.

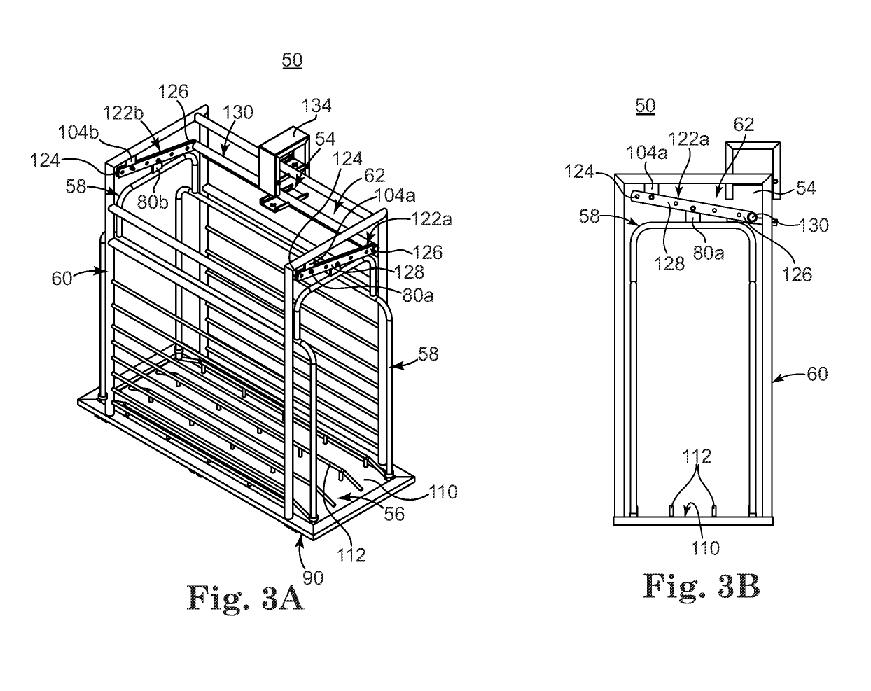

Assembly of the scale 50 is shown in FIGS. 3A and 3B. In general terms, the platform 56 is assembled to the hanger frame 58. In particular, the platform 56 is assembled to, or is directly supported by, the floor support 82 (FIG. 2). The platform 56 and the hanger frame 58, as assembled, combine to form or define a basket-like structure. The hanger frame 58/platform 56 is assembled to the support frame 60. For example, the hanger frame 58 is located within the support frame 60, with the platform 56 generally positioned within the base 90. The pivot frame 62 is employed to movably assemble the hanger frame 58 with the support frame 60, as well as to connect the so-assembled framework 52 with the load cell 54 (illustrated schematically in FIGS. 3A and 3B). The first pivot arm 122a is pivotably connected to the first offset hanger plate 104a at or adjacent the first end 124, and is pivotably connected to the first hanger plate 80a along the intermediate segment 128. The second pivot arm 122b is attached to the hanger plates 80b/104b in a similar manner. The load cell 54 (and related electronics) are mounted to the bracket 108 of the support frame 60, with the bracket 132 of the pivot frame 62 positioned to movably engage the load cell 54. A housing 134 can further be provided that exteriorly protects the load cell 54 and other electronics (e.g., transceiver, antenna, etc.).

With the above construction, the load cell 54 acts/places a force upon the load beam 130 (or resists downward movement of the load beam 130) that in turn is translated to the second end 126 of each of the pivot arms 122a, 122b. The second end 126 of each of the pivot arms 122a, 122b are thus forced, in tandem, upwardly, with the corresponding first end 124 being supported by, and pivoting relative to, the respective offset hanger plate 104a, 104b. The hanger frame 58 is thus supported (e.g., “lifted”) relative to the support frame 60 via interface between the pivot arms 122a, 122b and corresponding ones of the hanger plates 80a, 80b.

As a pig (not shown) passively chooses to walk across or otherwise stand on the floor 110 (or, more generally, as any object is placed on the floor 110), a downward force is imparted on to the platform 56. This force, in turn, is translated on to the load beam 130 via the hanger frame 58/pivot frame 62 as described above. The load cell 54 resists movement of the load beam 130, and senses a length of travel as is conventionally known. The sensed change in position of the load beam 130 (and other sensed force upon the load beam 130) as determined by the load cell 54 is indicative of a weight of the pig (or other object) on the platform 56. The so-sensed data can be converted by the load cell 54 (or other electronic device (not shown)), such as by converting to a voltage, and then signaling the information to a separate station (not shown), for example via the communication device (not shown).

The scale 50 as described above has a highly open construction that pigs find non-intimidating. The sides thereof as defined by the framework 52 are open, with only a spaced, horizontal support member slightly obscuring a field of view from within the framework 52. Further, the framework 52 does not include a ceiling or other structure/wall/panel that might otherwise render an interior of the framework 52 dark and/or cast shadows within the framework 52. Along these same lines, entrance or exit paths of the scale 50 are highly open, effectively defined by dimensions of the hanger frame 58. In some embodiments, for example, the entrance of exit opening has a height of at least 35 inches, alternatively at least 38 inches, alternatively at least 41 inches; and width of at least 15 inches alternatively at least 17 inches. In other words, an interior of, and access to and from, the framework 52 (and thus the scale 50) is non-intimidating to a pig. Also, the operation of the scale 50 in obtaining a weight of the pig on the platform 56 is quiet, and entails minimal movement of the platform 56 (e.g., movement on the order of 0.25 inch in the presence of a 200-pound hog). All of these features combine to promote acceptance of, and free choice interaction with, the scale 50 by pigs within a penned area. Further, the load cell 54 (and related electronics) is located well above ground level, and thus is not exposed to contaminants (e.g., manure) commonly associated with penned livestock.

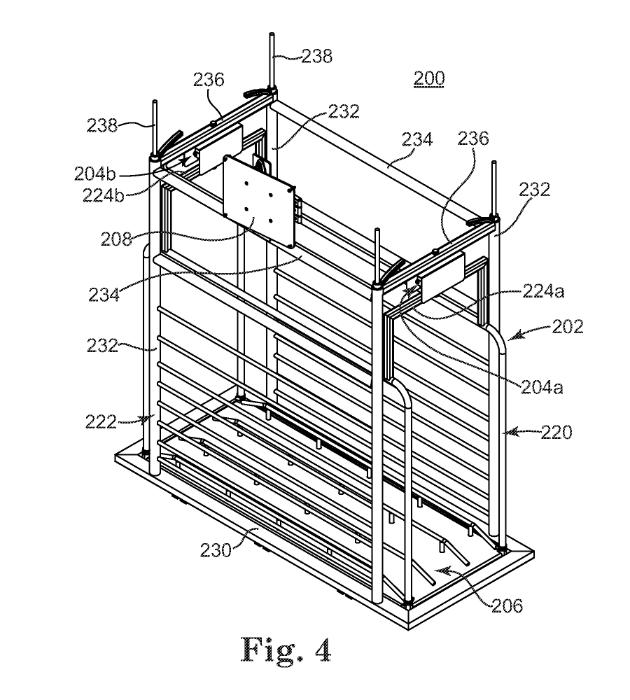

The scale 50 can be modified in various manners (e.g., materials, shape, dimensions, mode of operation, etc.). For example, FIG. 4 illustrates an alternative embodiment scale 200 in accordance with principles of the present disclosure and useful as the scale 18 with the methods and systems of FIG. 1. The scale 200 includes framework 202, two load cells 204a, 204b (shown in block form), and a platform 206. In many respects, the scale 200 is highly similar to the scale 50 (FIG. 3A) described above except that the framework 202 is configured to facilitate weight measurement via the dual load cells 204a, 204b. The framework 202 establishes a “hanging scale” relationship of the platform 206 relative to the load cells 204a, 204b that are otherwise maintained well above ground level. Though not shown, the load cells 204a, 204b are electronically linked (e.g., hard-wired or wirelessly linked) to a controller (not shown) otherwise maintained by the framework 202 (e.g., a mounting plate 208) that in turn processes and/or signals information/data from the load cells 204a, 204b to an external source (not shown).

The framework 202 includes a hanger frame 220 and a support frame 222. The hanger frame 220 is akin to the hanger frame 58 (FIG. 2) described above, and supports the platform 206. Opposing top struts 222a, 222b interconnect opposing side bars of the hanger frame 58, and are configured for mounting to a respective one of the load cells 204a, 204b. As with the scale 50, the hanger frame 220 effectively defines a size of the entrance/exit openings to the scale 200, having the dimensions described above, for example.

The support frame 222 is akin to the support frame 60 (FIG. 2), and includes a base 230 from which uprights 232 extend. Elongated side beams 234 interconnect opposing pairs of the uprights 232 opposite the base 230, as do opposing end supports 236. In this regard, the end supports 236 are configured for mounting to a respective one of the load cells 204a, 204b. Where desired, T-bolts 238 can be provided to reinforce the uprights 232.

The platform 206 can be identical to the platform 56 (FIG. 2), and is assembled to the hanger frame 220 as described above. The hanger frame 220 nests within the support frame 222 as shown, movably supported relative thereto via the load cells 204a, 204b. When a pig (or other animal) moves onto the platform 206, the length of travel of the hanger frame 220 relative to the support frame 222 is “sensed” by the load cells 204a, 204b, with this sensed information being indicative of a weight of the object upon the platform 206.

Although the present disclosure has been described with reference to preferred embodiments, workers skilled in the art will recognize that changes can be made in form and detail without departing from the spirit and scope of the present disclosure. For example, the scales described herein, as well as the related passive interaction by pigs during use thereof, can be employed in other environments in addition to a penned “living” area for the efficient acquisition of various biometrics (e.g., with applications in which pigs are routinely moved such as finish load-out, weaned sows back to breeding/gestation areas, etc.). Other normal activities relating to raising of livestock are also facilitated by the methods, systems, and scales of the present disclosure due to the openness of the scale configurations, such as visual assessment of animal condition, hand access for injections, ear tag cleaning/repair, video imaging or optical scanning for the estimation (or integration with body weight) of body lean mass ratio, sow condition per back fat indication, etc. Other features can be added to (or eliminated from) the scales described herein, such as portability features (e.g., wheels), markers, RFID, etc.

What is claimed is:

1. A method of obtaining weight information of pigs being reared in a penned area, the method comprising:
locating a scale in the penned area, the scale including a platform and characterized by the absence of solid walls or a ceiling;
allowing a pig to freely choose to interact with the platform; and
measuring a weight of the pig with a scale during while the pig interacts with the platform.

2. The method of claim 1, wherein the method is characterized by the absence of food or water being used to entice the pig to interact with the platform.

3. The method of claim 1, wherein the scale is further characterized by the absence of automated entry doors.

4. The method of claim 1, wherein allowing the pig to freely choose to interact with the platform includes the scale not inhibiting a natural curiosity of the pig to interact with the platform.

5. The method of claim 1, wherein the scale includes providing a scale comprising:
framework defining opposing ends, a top and bottom;
the platform being movably supported by the framework adjacent the bottom; and
at least one load cell connected to the platform via the framework;
wherein the load cell senses a weight on the platform.

6. The method of claim 5, wherein the framework includes:
a hanger frame; and
a support frame;
wherein the hanger frame is configured to maintain the platform and is movably connected to the support frame.

7. The method of claim 6, wherein the load cell is mounted to a portion of the hanger frame and a portion of the support frame.

8. The method of claim 7, wherein the load cell is positioned proximate the top of the framework.

9. The method of claim 6, wherein the hanger frame defines a size of an opening at both of the opposing ends, the opening having a height of at least 35 inches and a width of at least 14 inches.

10. The method of claim 5, wherein the scale is configured such that the platform travels a distance of less than 1.0 inch in the presence of a 200-pound weight.

11. The method of claim 5, wherein the scale further comprises:
a controller electronically connected to the at least one load cell, the controller programmed to signal information indicative of a weight sensed by the load cell.
